(19) United States
(12) Patent Application Publication
(10) Pub. No.: US 2020/0293710 A1
(43) Pub. Date: Sep. 17, 2020

(54) METHOD, APPARATUS, AND NON-TRANSITORY COMPUTER-READABLE STORAGE MEDIUM FOR STORING PROGRAM FOR CALCULATING COUPLING ROUTE OF MECHANICAL PART

(71) Applicant: FUJITSU LIMITED, Kawasaki-shi (JP)

(72) Inventors: Yoshiaki Hiratsuka, Ota (JP); Koji DEMIZU, Atsugi (JP)

(73) Assignee: FUJITSU LIMITED, Kawasaki-shi (JP)

(21) Appl. No.: 16/782,475

(22) Filed: Feb. 5, 2020

(30) Foreign Application Priority Data
Mar. 15, 2019 (JP) 2019-048905

(51) Int. Cl. G06F 30/394; G06F 30/31

(52) U.S. Cl. CPC G06F 30/394; G06F 2119/10; G06F 30/31

(57) ABSTRACT

A non-transitory computer-readable storage medium for storing a program which causes a processor to perform processing for calculating a coupling route of mechanical parts, the processing includes: extracting, from CAD data, information on each of a plurality of routes through which electricity is capable of flowing from a plurality of the mechanical parts constituting a conductive structure excluding an electronic part mounted over a substrate, to the substrate; extracting each of a coupling surface and a coupling point between the mechanical parts or between the mechanical part and the electronic part; calculating each of distances between the extracted coupling points; selecting a route having a shortest distance among the plurality of routes from a specific mechanical part in the plurality of mechanical parts to the substrate; and outputting the selected shortest route.

### CROSS-REFERENCE TO RELATED APPLICATION

This application is based upon and claims the benefit of priority of the prior Japanese Patent Application No. 2019-48905, filed on Mar. 15, 2019, the entire contents of which are incorporated herein by reference.

### FIELD

The embodiments discussed herein are related to a method, an apparatus, and a non-transitory computer-readable storage medium storing a program for calculating a coupling route of a mechanical part.

### BACKGROUND

In a design of an electronic apparatus, in order to suppress electrical noise, conductive mechanical parts (hereinafter simply referred to as “mechanical parts”) are designed by visually checking, with a current tool, whether or not each mechanical part is coupled to a printed substrate (including electrical parts) of a noise radiation source or is coupled in a shortest route.

There has been known a technique in which a plurality of parts are divided into configuration parts having a size equal to or smaller than a designated maximum size, and the shortest distances in respective portions are totally measured.

Examples of the related art include Japanese Laid-open Patent Publication No. 2006-155379 and Japanese Laid-open Patent Publication No. 2009-276928.

### SUMMARY

According to an aspect of the embodiments, provided is a non-transitory computer-readable storage medium for storing a program which causes a processor to perform processing for calculating a coupling route of mechanical parts. The processing includes: extracting, from CAD data, information on each of a plurality of routes through which electricity is capable of flowing from a plurality of the mechanical parts constituting a conductive structure excluding an electronic part mounted over a substrate, to the substrate; extracting each of a coupling surface and a coupling point between the mechanical parts or between the mechanical part and the electronic part; calculating each of distances between the extracted coupling points; selecting a route having a shortest distance among the plurality of routes from a specific mechanical part in the plurality of mechanical parts to the substrate; and outputting the selected shortest route.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIGS. 1A and 1B illustrate a diagram for explaining a route through which noise propagates;

FIG. 2 illustrates a hardware configuration example of a coupling route calculation apparatus;

FIG. 3 illustrates a functional configuration example of the coupling route calculation apparatus;

FIG. 4 is a diagram for explaining a coupling route calculation process;

FIG. 5 illustrates a data configuration example of a part information table;

FIGS. 6A and 6B illustrate a view for explaining a coupling example of parts;

FIG. 7 illustrates an example of a coupling portion for collecting coupling information from a part configuration illustrated in FIG. 1(A);

FIG. 8 illustrates a data configuration example of a part coupling table;

FIG. 9 illustrates a data configuration example of an all-route table;

FIGS. 10A and 10B illustrate a view for explaining a coupling surface;

FIG. 11 illustrates a data configuration example of a coupling surface table;

FIGS. 12A and 12B and 12C illustrate a view for explaining a first example of a coupling point disposition method;

FIG. 13 illustrates a data configuration example of a coupling point table;

FIG. 14 illustrates a combination of coupling points for calculating a distance;

FIG. 15 illustrates an example in which each coupling point is specified in a part configuration;

FIG. 16 illustrates a data configuration example of a coupling point distance table;

FIG. 17 illustrates a data configuration example of a route distance table;

FIG. 18 is a view for explaining a shortest path;

FIG. 19 is a view for explaining an example in which a priority determination is performed by comparing volumes of a plurality of parts in a priority determination process;

FIG. 20 is a view for explaining an example in which the priority determination is performed by comparing coupling areas of the plurality of parts in the priority determination process;

FIG. 21 illustrates a data configuration example of a shortest route table;

FIG. 22 illustrates a display example of a shortest route over a part configuration;

FIGS. 23A and 23B illustrate a view for explaining a second example of the coupling point disposition method; and

FIGS. 24A and 24B illustrate a view for explaining a third example of the coupling point disposition method.

### DESCRIPTION OF EMBODIMENT(S)

When a plurality of mechanical parts are stacked over a printed substrate while being electrically coupled to each other, electrical noise (simply referred to as “noise”) propagating through each mechanical part is propagated in various directions via the mechanical parts in a coupling relationship.

The mechanical parts respectively have various shapes and sizes. Therefore, even if the number of the mechanical parts of the route through which noise obtained based on the coupling relationship between the mechanical parts is small, it is not necessarily designed to be the shortest distance to the printed substrate to be capable of suppressing noise.

There is a problem that a designer checks the route from the electronic part to the printed substrate, and may specify the shortest distance based on knowledge and skill such as a shape, a size, and characteristics of the electronic part when noise propagates.

Therefore, in one aspect, an object of embodiments is to facilitate check of a route through which noise propagates regardless of the skill of the designer.

It is possible to easily check a route through which noise propagates regardless of skill of a designer.

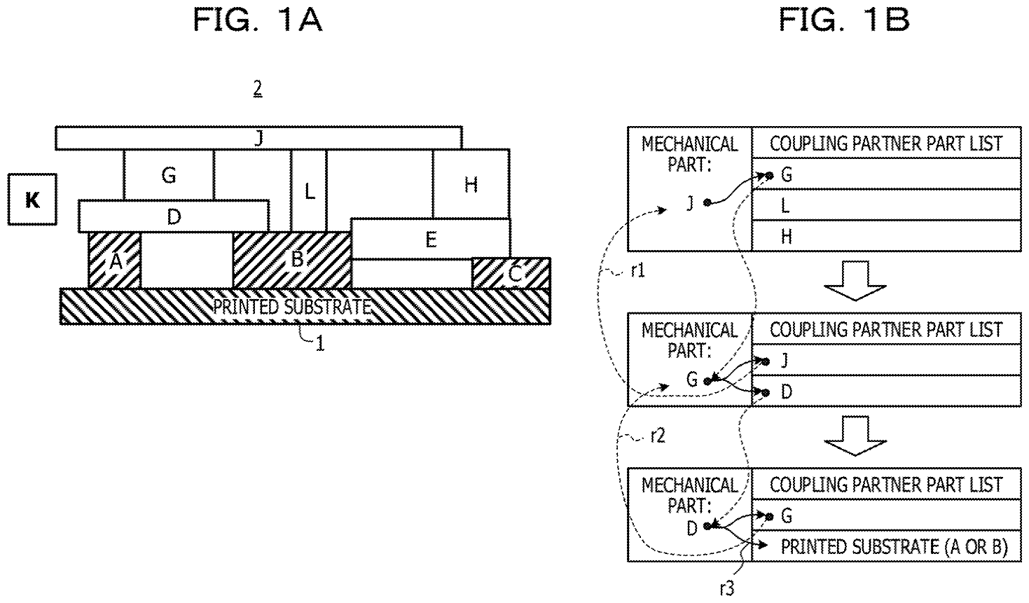

Hereinafter, embodiments are described with reference to the drawings. FIG. 1 (i.e., FIGS. 1A and 1B) is a diagram for explaining a route through which noise propagates. FIG. 1A illustrates a part configuration example. In FIG. 1A, parts A, B, and C which are directly mounted on a printed substrate 1 are referred to as electrical parts and are regarded as being integrated into the printed substrate 1. That is, when noise propagates to the electrical part A, B, or C, the noise is considered to propagate to the printed substrate 1.

Conductive parts disposed in a part configuration 2 are referred to as mechanical parts. In the part configuration 2, parts D, E, G, H, J, and K are mechanical parts that form a conductive structure. Of these mechanical parts, the parts D, E, G, H, and J are electrically directly coupled or indirectly coupled to one or more of the electrical parts A, B, and C, and are stacked on the printed substrate 1. The mechanical part K is a part disposed in the part configuration 2 while not being electrically directly coupled or indirectly coupled to the printed substrate 1. The electrical part and the mechanical part may be collectively referred to as “part”.

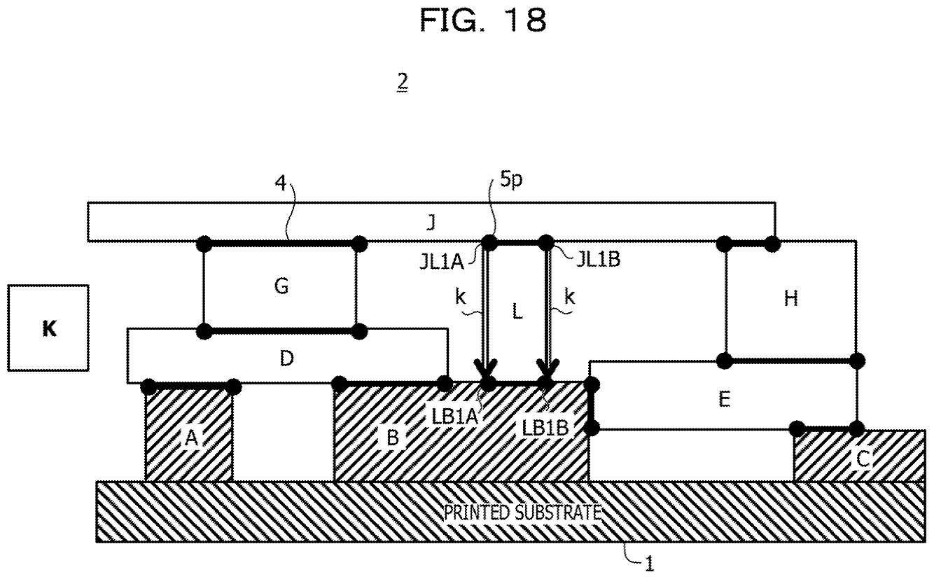

FIG. 18 illustrates a route based on a coupling relationship among the mechanical parts J, G, and D in the part configuration 2 of FIG. 1A. The route includes all routes through which electro-magnetic compatibility (EMC) noise propagates.

When each mechanical part is set as a starting point, the mechanical part to which the EMC noise propagates is route-searched by referring to a table in which coupling partners are listed. In this example, a data example relating to the mechanical parts J, G, and D is illustrated.

Usually, all routes are searched from an uppermost mechanical part J of the part configuration 2. Routes r1, r2, and r3 are specified from the mechanical part J.

Among these, the route r1 returns to the mechanical part J of the starting part via the mechanical parts G and J. The route r2 returns to the mechanical part G again via the mechanical parts G and J. The route returning to either the mechanical part that started the route search or a middle mechanical part is excluded because it is not suitable for suppressing the EMC noise. The mechanical part K that may not be specified by the coupling partner is also excluded because it is not coupled to the printed substrate 1.

Therefore, a route coupled to the printed substrate (A or B) is the route r3 of the mechanical part J->the mechanical part G->the mechanical part D->the printed substrate (A or B), and it may be determined that the EMC noise may be suppressed because the route r3 may be specified. However, it is not possible to determine whether or not the route is a shortest route.

In the route search based on the coupling relationship between the mechanical parts, it is possible to determine whether the printed substrate 1 is directly coupled or indirectly coupled (hereinafter simply referred to as “coupling”), but it is difficult to determine the shortest route. For example, in the route r3, the mechanical part J is coupled to both the electrical part A and the electrical part B. Even when the mechanical part J is coupled to both of the electrical part A and the electrical part B, the same route r3 is obtained.

However, a distance when being coupled from the mechanical part G to the electrical part A via the mechanical part D is different from a distance when being coupled to the electrical part B. Therefore, even if the route r3 may be specified by using a tool capable of existing route searching, the shortest route may not be specified. Check of a route or a non-coupled portion which does not follow the printed substrate 1 is visually performed. As a result, a designer visually checks the part configuration 2 and, based on knowledge and skill, checks all routes which are equal to or more than thousands, so that there is a variation in product quality due to omission of check or wrong determination.

In the present example, the route to the printed substrate 1 is extracted in consideration of a shape, a size, and the like of the mechanical part to facilitate check by the designer. The shortest route among the routes to the printed substrate 1 may be specified with high accuracy.

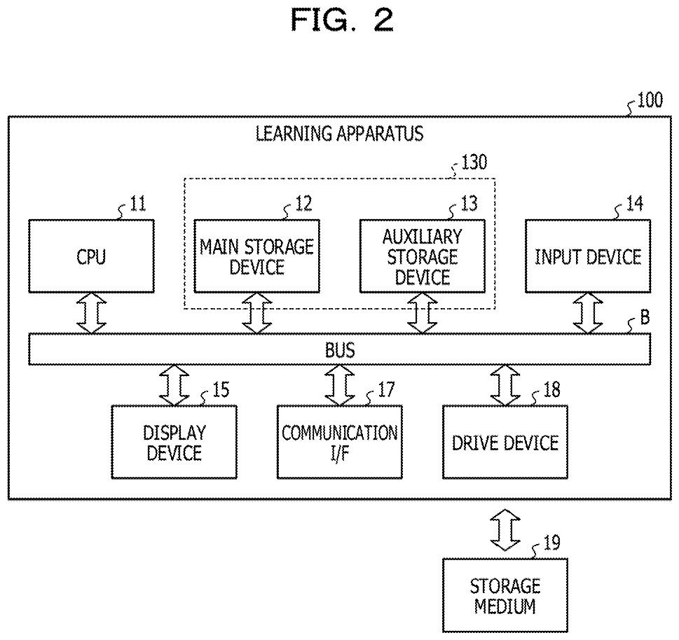

The coupling route calculation apparatus for realizing the present example has a hardware configuration as illustrated in FIG. 2. FIG. 2 is a diagram illustrating a hardware configuration example of the coupling route calculation apparatus. A coupling route calculation apparatus 100 illustrated in FIG. 2 is an information processing apparatus, and includes a CPU 11, a main storage device 12, an auxiliary storage device 13, an input device 14, a display device 15, a communication I/F 17, and a drive device 18, which are coupled by a bus B. The main storage device 12 and the auxiliary storage device 13, and an external storage device, to which the coupling route calculation apparatus 100 is able to access, are collectively referred to as a storage unit 130.

The CPU 11 corresponds to a processor that controls the coupling route calculation apparatus 100 and realizes various processes according to the present example described later by executing a program stored in the storage unit 130. The input device 14 is operated by the designer and receives data in response to the operation, and the display device 15 displays various screens as a user interface. The communication I/F 17 controls communication with an external device.

A coupling route calculation program according to the present example stored in a storage medium 19 (for example, a compact disc read-only memory (CD-ROM) is installed in the storage unit 130 via the drive device 18, and may be executed by the CPU 11.

The storage medium 19 for storing the program according to the present example is not limited to the CD-ROM, and may be any one or more non-transitory, tangible media having a computer readable structure. As the computer-readable storage medium, in addition to the CD-ROM, a digital versatile disk (DVD), a portable recording medium such as a USB memory, or a semiconductor memory such as a flash memory may be used.

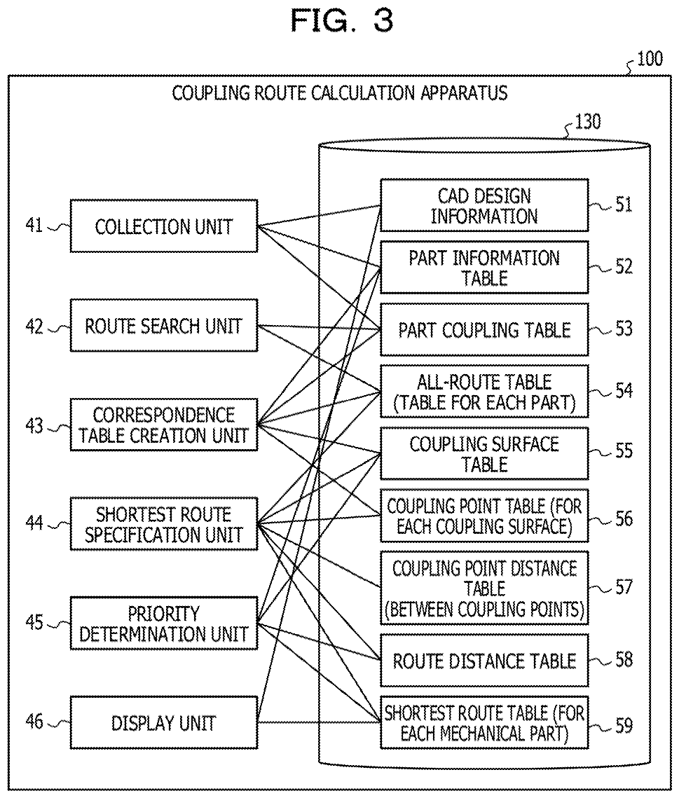

FIG. 3 is a diagram illustrating a functional configuration example of the coupling route calculation apparatus. In FIG. 3, the coupling route calculation apparatus 100 includes a collection unit 41, a route search unit 42, a correspondence table creation unit 43, a shortest route specification unit 44, a priority determination unit 45, and a display unit 46. The collection unit 41, the route search unit 42, the correspondence table creation unit 43, the shortest route specification unit 44, the priority determination unit 45, and the display unit 46 are realized by a process executed by the CPU 11 of the coupling route calculation apparatus 100 by a program installed in the coupling route calculation apparatus 100.

The storage unit 130 stores computer-aided design (CAD) information 51, a part information table 52, a part coupling table 53, an all-route table 54, a coupling surface table 55, a coupling point table 56, a coupling point distance table 57, a route distance table 58, and a shortest route table 59.

The collection unit 41 creates the part information table 52 and the part coupling table 53, and stores them in the storage unit 130. The collection unit 41 acquires part information of each of the electrical parts A, B, and C, and the mechanical parts J, G, D, L, E, H, and K from the CAD design information 51 of the part configuration 2 stored in the storage unit 130, creates the part information table 52, and stores the part information table in the storage unit 130. The collection unit 41 specifies a part coupled to each of the mechanical parts J, G, D, L, E, H, and K from the CAD design information 51 of the part configuration 2, creates the part coupling table 53, and stores the part coupling table in the storage unit 130. The part coupling table 53 indicates that there is no coupling part with respect to the mechanical part K without coupling.

The route search unit 42 searches all routes coupled to the printed substrate 1 starting from each of the mechanical parts J, G, D, L, E, and H coupled to other mechanical parts with reference to the part coupling table 53, creates the all-route table 54, and stores the all-route table in the storage unit 130.

The correspondence table creation unit 43 obtains a surface (coupling surface) on which parts are coupled to each other, creates the coupling surface table 55, specifies a corner portion of the obtained surface as a coupling point, and creates the coupling point table 56.

The correspondence table creation unit 43 acquires a combination of two parts to be coupled with reference to the part coupling table 53, obtains an area (coupling area) of the coupling surface with reference to the part information table 52, creates the coupling surface table 55, and stores the coupling surface table in the storage unit 130. The correspondence table creation unit 43 uses the created coupling surface table 55 to dispose a coupling point over a surface of an upper part for each coupling surface, creates the coupling point table 56 indicating a list of the disposed coupling points, and stores the coupling point table in the storage unit 130.

The shortest route specification unit 44 calculates a distance for each combination of a coupling point of a coupling source and a coupling point of a coupling destination for each coupling of parts along a route starting from a part designated by the designer, creates the coupling point distance table 57, and stores the coupling point distance table in the storage unit 130. For one part, the coupling point of the coupling source corresponds to each coupling point on the coupling surface of the part opposite to a printed substrate 1 side. Similarly, the coupling point of the coupling destination corresponds to each coupling point on the coupling surface of the part on the printed substrate 1 side.

The shortest route specification unit 44 uses the coupling point distance table 57 to acquire a route with the coupling point of each coupling source in the part designated by the designer as the starting point. The shortest route specification unit 44 calculates the route distance by adding up the distances between the coupling points for each route. The route distance table 58 indicating the route distance is created and stored in the storage unit 130. In the route distance table 58, a plurality of route distances are indicated for one route.

The shortest route specification unit 44 specifies the shortest route based on all the distances obtained from the all-route table 54. The shortest route table 59 including the information of the shortest route is created and stored in the storage unit 130.

The priority determination unit 45 determines paths between coupling points to be preferentially selected when the paths are the same route but are coupled to two or more electrical parts at the coupling destination. As an example, in FIG. 1A, the mechanical parts D and E coupled to two or more parts at the coupling destination correspond to this case.

The priority determination unit 45 determines, from the route distance table 58, whether to select a path to any part of the coupling destination in the corresponding route based on the size of each volume of the part of the coupling destination or the area (hereinafter simply referred to as “coupling area”) of the coupling surface, for parts in which distances of the coupling points are equal from the designated part to the printed substrate 1.

When the priority determination is made based on the volume, the priority determination unit 45 refers to the part information table 52. When the priority determination is made based on the coupling area, the priority determination unit 45 refers to the coupling surface table 55. The route selected by the priority determination unit 45 is indicated in the shortest route table 59.

The display unit 46 displays the part configuration 2 on the display device 15 based on the CAD design information 51 according to an operation of the designer, and notifies the collection unit 41 of an identifier of the part in accordance with the designation of one or a plurality of mechanical parts by the designer. By this notification, the coupling route calculation process according to the present example is started.

The display unit 46 indicates the shortest route over the part configuration 2 displayed based on the CAD design information 51 in accordance with the completion of the creation of the shortest route table 59. The display unit 46 easily displays the mechanical parts without coupling detected in the process of the coupling route calculation process.

The CAD design information 51 includes design information of the part configuration 2 designed by using the CAD by the designer. The CAD design information 51 indicates the shape, disposition coordinates, electrical characteristics (presence or absence of electrical conductivity), a material, a volume, and the like of each part disposed over the printed substrate 1.

After the coupling route calculation process by the coupling route calculation apparatus 100 according to the present example is described, the part information table 52, the part coupling table 53, the all-route table 54, the coupling surface table 55, the coupling point table 56, the coupling point distance table 57, the route distance table 58, and the shortest route table 59 will be described respectively.

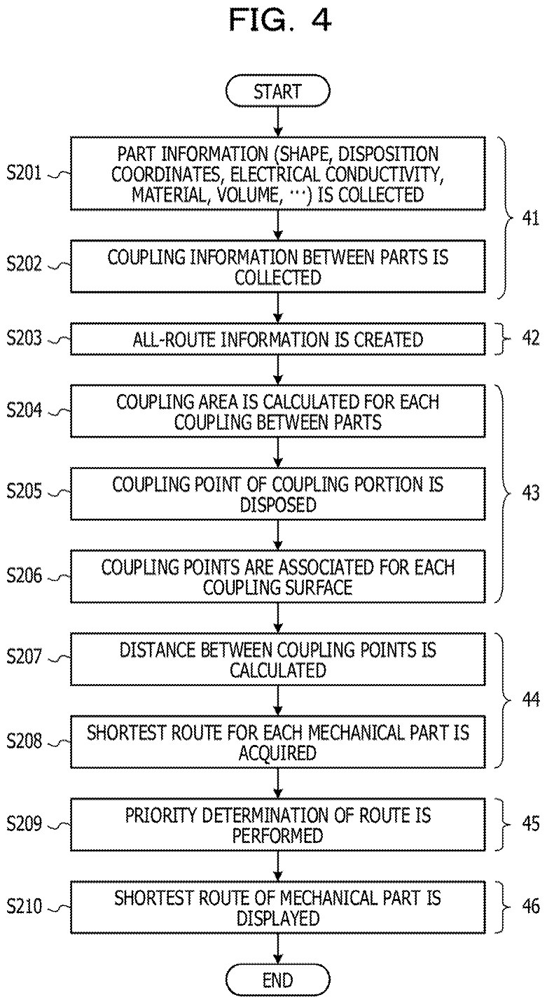

FIG. 4 is a diagram for explaining the coupling route calculation process. Referring to FIG. 4, in response to the notification of the identifier of the part designated by the designer from a display unit 48, the collection unit 41 collects the part information from the CAD design information 51, creates the part information table 52, and stores the part information table in the storage unit 130 (step S201). Information such as the shape, the disposition coordinates, the electrical conductivity, the material, and the volume is collected and stored in the part information table 52.

The collection unit 41 collects coupling information between the parts from the CAD design information 51, creates the part coupling table 53, and stores the part coupling table in the storage unit 130 (step S202). When the mechanical part is coupled to the electrical part, the collection unit 41 may add information such as “distance 0 mm” as supplementary information. For example, in a case where a part which is not coupled to any part exists, the collection unit 41 may indicate that there is no part to be coupled in the part coupling table 53. By referring to the created part coupling table 53, it is possible to specify the part to be coupled for each part.

Next, the route search unit 42 uses the part coupling table 53 to make each part as a starting part, searches for the route to the printed substrate 1, creates all-route information, and stores the all-route table 54, in which the created all-route information is listed, in the storage unit 130 (step S203).

The correspondence table creation unit 43 acquires a coupling surface based on the part information table 55 for each combination of two parts to be coupled extracted from the part coupling table 53, calculates a coupling area based on the specified coupling surface, creates the coupling surface table 52, and stores the coupling surface table in the storage unit 130 (step S204).

Based on the coupling surface, the correspondence table creation unit 43 disposes the coupling point of the coupling portion in mesh point coordinates determined in advance (step S205). The correspondence table creation unit 43 creates the coupling point table 56 in which coupling points are associated with each other for each coupling surface, and stores the coupling point table in the storage unit 130 (step S206).

Next, the shortest route specification unit 44 calculates a distance between the coupling points (step S207), and acquires the shortest route for each mechanical part (step S208). The shortest route specification unit 44 specifies a coupling surface from the coupling surface table 55 for each coupling for each route indicated in the all-route table 54, and acquires the coupling point by referring to the coupling point table 56 by using the specified coupling surface. The shortest route specification unit 44 calculates all distances from the coupling point of the coupling source to the coupling point of the coupling destination. One or more routes may exist for one mechanical part in the coupling part. Further, there may be a plurality of paths (hereinafter referred to as “coupling point paths”) by the coupling point for one route.

The shortest route specification unit 44 may specify the route to which the shortest coupling point path belongs in all of one or more routes. The route distance table 58 including information of the specified route and distance is output to the storage unit 130. If the coupling point paths having the same shortest distance are specified by the shortest route specification unit 44 for each of two or more routes, step S209 is performed. When only one route is specified, the coupling route calculation process skips step S209, and proceeds to step S210.

When two or more routes are specified by the shortest route specification unit 44, the priority determination unit 45 determines the priority of the route (step S209). The priority determination unit 45 determines a route to be preferentially selected by using a volume or a coupling area of a part to be the coupling destination. The method of the priority determination will be described later.

The display unit 46 displays the shortest route of the mechanical part on the display device 15 (step S210). The designer may designate one or a plurality of mechanical parts. Among the routes starting from the designated mechanical part, the shortest route and the distance thereof are displayed for each mechanical part. When the designer newly designates a part, the display unit 46 notifies the collection unit 41 of the identifier of the part, and the same process as described above is repeated. By a termination operation of the designer, the coupling route calculation process by the coupling route calculation apparatus 100 is terminated.

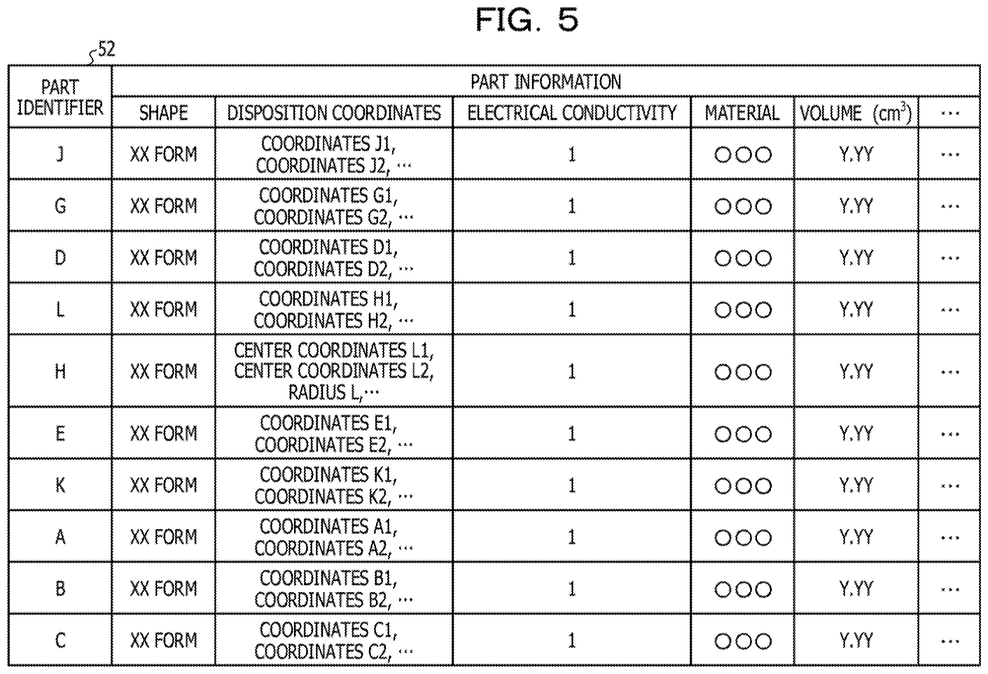

FIG. 5 is a table illustrating a data configuration example of a part information table. As illustrated in FIG. 5, the part information table 52 is a table storing part information for each part included in the part configuration 2, extracted from the CAD design information 51 by the collection unit 41, and has items such as the part identifier and the part information.

The part identifier indicates the identifier capable of uniquely specifying the part in the part configuration 2. The part information includes values such as the shape, the coordinates, the electrical conductivity, the material, and the volume (cm³). Each piece of the part information of the mechanical parts J, G, D, L, H, E, and K, and the electrical parts A, B, and C is indicated.

Definitions of the coupling between the parts are illustrated below.
Coupling: contact and interference are combined to make coupling.
Contact: a state where shapes of two parts are in contact with each other
Interference: a state where shapes of two parts are overlapped with each other

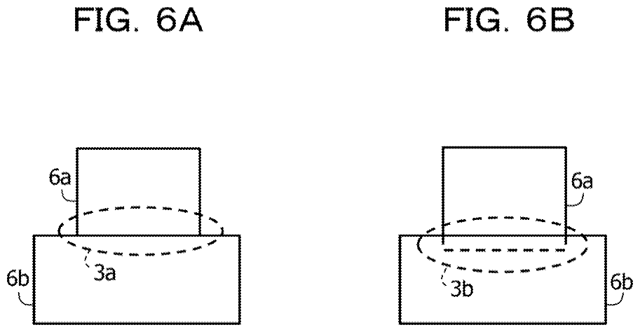

FIG. 6 (i.e., FIGS. 6A and 6B) is a view for explaining a coupling example of parts. In FIG. 6, a description will be given of a case where a part 6a is stacked over a part 6b.

FIG. 6A illustrates a contact example of the coupling. A coupling state 3a, in which surfaces of the part 6b and the part 6a are in contact with each other, corresponds to the contact state. FIG. 6B illustrates an example of the interference of the coupling. The coupling state 3b in which one part (in this example, the part 6a) is embedded in the other part (in this example, the part 6b) corresponds to the interference.

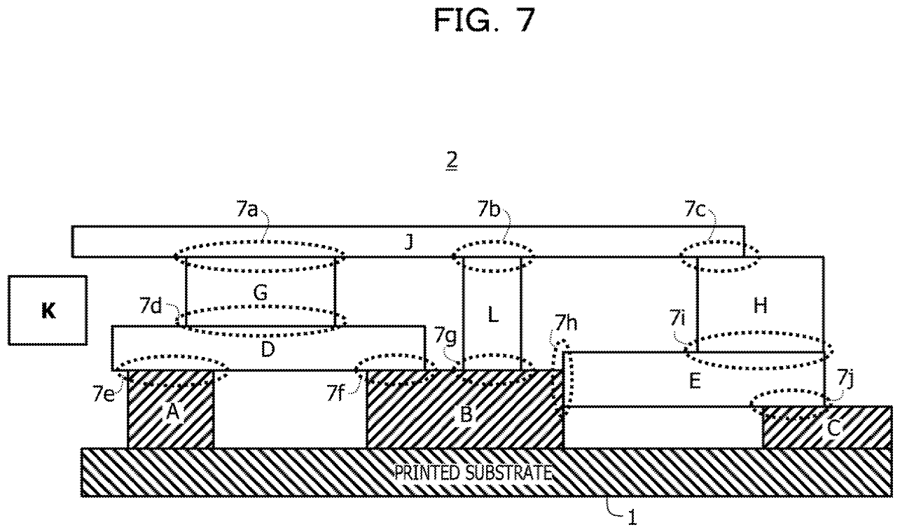

FIG. 7 is a view illustrating an example of the coupling portion for collecting coupling information from the part configuration illustrated in FIG. 1A. In FIG. 7, coupling portions for collecting coupling information from the CAD design information 51 by the collection unit 41 are illustrated by being surrounded with dotted lines. Coupling information is collected from a total of ten portions.

For the part J, the collection unit 41 specifies the part G from a coupling portion 7a, specifies the part L from a coupling portion 7b, and specifies the part H from a coupling portion 7c. For the part G, the collection unit 41 specifies the part J from the coupling portion 7a, specifies the part D from a coupling portion 7d, and similarly, for the part D, specifies the part G from the coupling portion 7d, specifies the part A from a coupling portion 7e, and specifies the part B from a coupling portion 7f.

Similarly, for the part L, the collection unit 41 specifies the part J from the coupling portion 7b, and specifies the part B from a coupling portion 7g. For the part H, the collection unit 41 specifies the part H from the coupling portion 7c and specifies the part E from a coupling portion 7i, and for the part E, specifies the part B from a coupling portion 7h, specifies the part H from the coupling portion 7i, and specifies the part C from a coupling portion 7j. For the part K, since a coupling portion does not exist, the collection unit 41 determines that there is no part to be coupled to the part K.

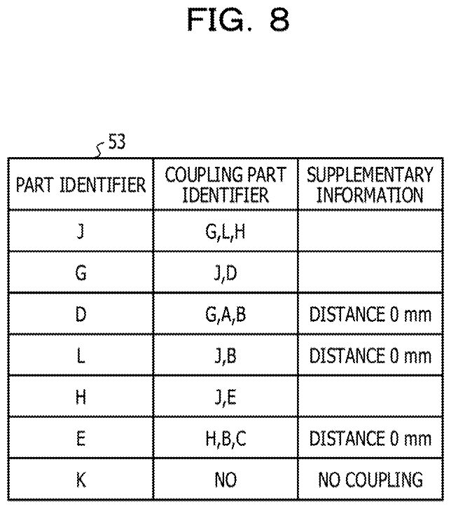

By the process of the collection unit 41 as described above, the part coupling table 53 as illustrated in FIG. 8 is stored in the storage unit 130. FIG. 8 is a table illustrating a data configuration example of the part coupling table. As illustrated in FIG. 8, the part coupling table 53 is a table indicating a coupling relationship between parts relating to mechanical parts collected from the CAD design information 51 by the collection unit 41, indicates parts coupled to themselves for each part (mechanical part), and includes items such as a part identifier, a coupling part identifier, and supplementary information.

The part identifier indicates the identifier capable of uniquely specifying the part in the part configuration 2. The coupling part identifier indicates all of the part identifiers of the parts to be coupled. For a non-coupled part, “no” is set to indicate that there is no coupling part. The supplementary information is set to information that does not require the calculation of the distance between coupling points described later, but, for example, is not limited to the information to be set.

In the data configuration example of FIG. 8, it is illustrated that the coupling parts of the part J are parts G, L, and H, and the coupling parts of the parts G are parts J and D. Since the coupling parts of the part D are the parts G, A, and B, and are directly coupled to the electrical parts A and B, the distance calculation between the coupling points may be undesirable in such a case. Accordingly, information such as “distance 0 mm” may be set for the supplementary information.

The coupling parts of the parts L, H, and E are also respectively illustrated, and for the parts L and E, the “distance 0 mm” is set in the supplementary information. The part K is indicated to have no coupling part. Information such as “not coupled” may be set to the supplementary information of the part K.

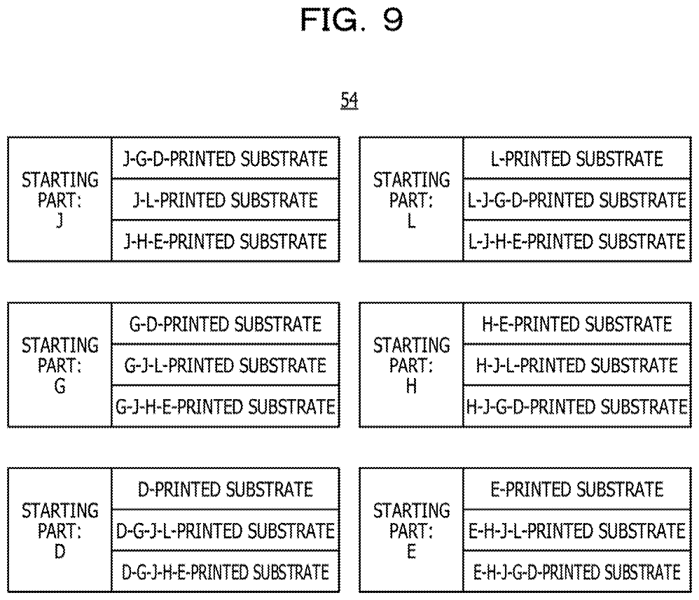

FIG. 9 is a view illustrating a data configuration example of the all-route table. In FIG. 9, the all-route table 54 is a table indicating all routes up to the printed substrate 1 (electrical part A, B, or C) for each of the mechanical parts in the part configuration 2. For example, all routes are searched by the route search unit 42 for each of the parts J, G, D, L, H, and E.

In the data configuration example illustrated in FIG. 9, in the case of the starting part J, three routes exist. A first route is the part J->the part G->the part D->the printed substrate 1. A second route is the part J->the part L->the printed substrate 1. A third route is the part J->the part H>the part E->the printed substrate 1.

Also in the case of the part G coupled to a bottom surface of the part J, three routes exist. The first route is the part G->the part D->the printed substrate 1. The second route is the part G->the part J->the part L->the printed substrate 1. The second route is a detour route which is directed to the part J which is a direction away from the printed substrate 1 from the part G, and which reaches the printed substrate 1 from the part J via the part L. The third route is the part G->the part J->the part H->the part E->the printed substrate 1, and this route is also a detour route. Other than the part J farthest from the printed substrate 1, a detour route is included.

For each of the parts D, L, H, and E, three routes exist, and at least one or more detour routes is included. As illustrated in FIG. 9, the part K without the coupling part is not included in the all-route table 54.

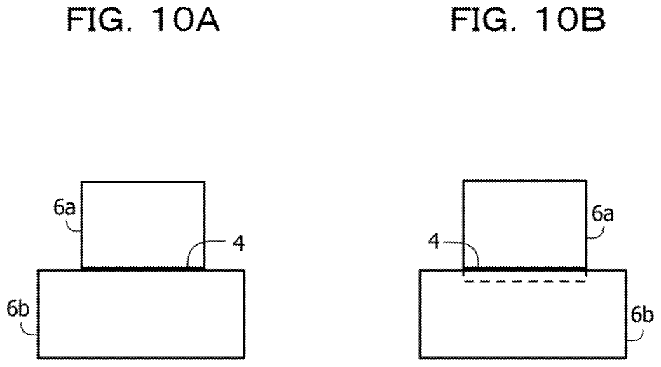

Next, a coupling surface associated with the correspondence table creation process by the correspondence table creation unit 43 will be described. FIG. 10 (i.e., FIGS. 10A and 108) is a view for explaining the coupling surface. In FIG. 10, the parts 6a and 6b illustrated in FIG. 6 will be described.

FIG. 10A illustrates the coupling surface 4 in a case where the part 6a and the part 6b are coupled to each other by contact. A region in which the part 6a is in contact with the part 6b is the coupling surface 4. FIG. 10B illustrates the coupling surface 4 in a case where the part 6a and the part 6b are coupled to each other by interference with each other. Although the part 6a is embedded in the part 6b, a section of the part 6a on the surface of the part 6b in which the part 6a is embedded corresponds to the coupling surface 4.

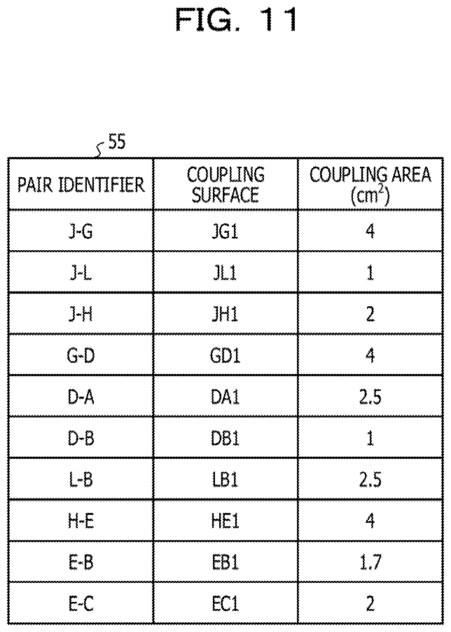

The correspondence table creation unit 43 specifies the coupling surface for each of the coupling portions 7a to 7j illustrated in FIG. 7, and obtains a coupling area. The coupling portions 7a to 7j illustrated in FIG. 7 are obtained from the part coupling table 53 illustrated in FIG. 8. The coupling surface may be calculated by using the shape, disposition coordinates, and the like of the part information table 52 illustrated in FIG. 5. The coupling area may be obtained from the specified coupling surface 4. The coupling surface table 55 as illustrated in FIG. 11 is created by the correspondence table creation unit 43 and stored in the storage unit 130.

FIG. 11 is a table illustrating a data configuration example of a coupling surface table. In FIG. 11, the coupling surface table 55 is a table in which an identifier of the coupling surface and a coupling area are recorded for each of the coupling portions 7a to 7j, and includes items such as a pair identifier, a coupling surface, and a coupling area.

The pair identifier indicates the identifier of two parts to be coupled. The coupling surface indicates information that uniquely specifies the coupling surface 4 of the two parts. The identifier may be uniquely created for each coupling surface. The coupling area indicates a value of the coupling area calculated by the correspondence table creation unit 43.

In the data configuration example illustrated in FIG. 11, it is illustrated that a coupling area of a coupling surface “JG1” is “4” cm³ in a pair identifier “J-G” specifying the coupling portion 7a. The same is true for each of the coupling portions 7b to 7j. Although FIG. 11 illustrates an example in which the coupling surfaces are only one surface in the coupling portions 7a to 7j, the number, the shape, and the like of the coupling surfaces are different A coupling point disposition method for disposing coupling points corresponding to the number, the shape, and the like of the coupling surfaces will be described.

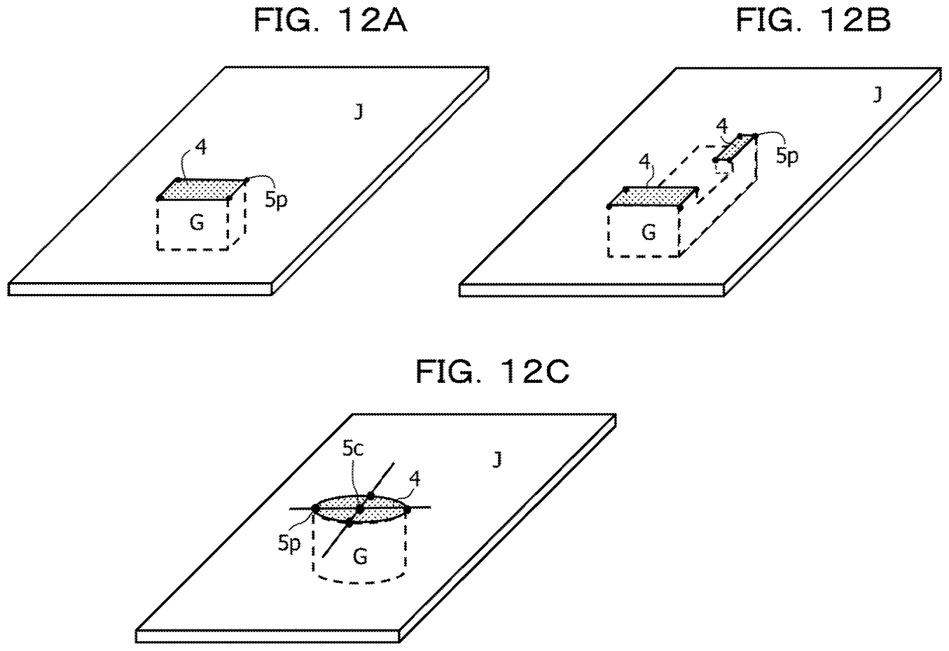

FIG. 12 (FIGS. 12A and 12B and 12C) is a view for explaining a first example of the coupling point disposition method. FIG. 12A illustrates an example in which the coupling surface 4 is one surface. Description will be given in a case where the shape of the part G coupled to the part J is a hexahedron (rectangular parallelepiped, cube, or the like). The correspondence table creation unit 43 disposes a coupling point 5p at a corner portion where sides over a side of the coupling surface 4 are in contact with each other in a CAD space. In this example, four coupling points 5p are disposed. A uniquely specified identifier may be assigned to each of the disposed coupling points 5p. The coordinates after the disposition may be stored in the storage unit 130 in association with the identifier. Management of the coupling point 5p is the same as below.

FIG. 12B illustrates an example in which a plurality of coupling surfaces 4 are provided. FIG. 12B illustrates an example in which the part G is coupled to the part J at two places due to a complicated shape of the part G. Therefore, two coupling surfaces 4 exist. Similarly to the example illustrated in FIG. 12A, the correspondence table creation unit 43 disposes four coupling points 5p for each coupling surface 4, and assigns an identifier to each coupling point 5p.

FIG. 12C illustrates an example in which the coupling surface 4 is a circle, an ellipse, or the like. In FIG. 12C, description will be given in a case where the shape of the part G is a cylindrical shape. In the disposition of the coupling points 5p in this example, unlike in FIGS. 12A and 12B, the correspondence table creation unit 43 creates two straight lines perpendicular to each other passing through a center point 5c over the coupling surface 4, defines four points where two straight lines intersect an outer circumference of a circle as the coupling points 5p, disposes four coupling points 5p in the CAD coordinate space, and assigns an identifier to each coupling point 5p.

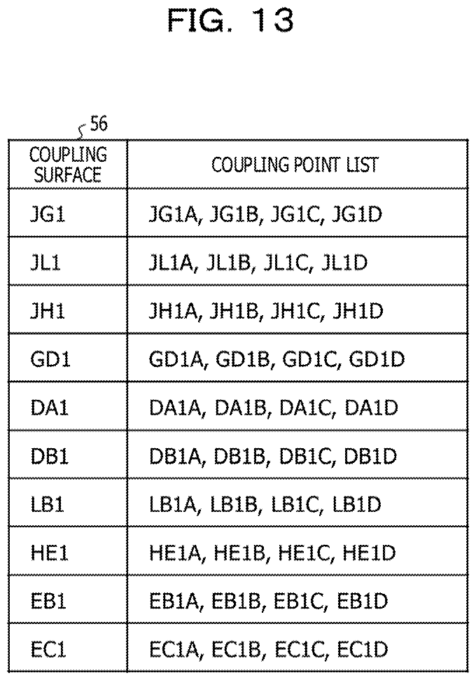

FIG. 13 is a table illustrating a data configuration example of the coupling point table. The coupling point table 56 illustrated in FIG. 13 is a table created by the correspondence table creation unit 43 and associated with coupling points determined for each coupling surface, and includes items such as a coupling surface and a coupling point list. The coupling surface is indicated by one of the identifiers of the coupling surfaces existing in the coupling surface table 55. The coupling point list indicates all of the coupling points defined with respect to the coupling surface 4 with identifiers.

In this example, four coupling points “JG1A”, “JG1B”, “JG1C”, and “JG1D” are defined for the coupling surface “JG1”. For the coupling surface “JL1”, four coupling points “JL1A”, “JL1B”, “JL1C”, and “JL1D” are defined. Similarly, coupling points are defined for the other coupling surfaces.

Next, the shortest route specifying process by the shortest route specification unit 44 will be described. The shortest route specification unit 44 calculates a distance to all combinations of a coupling point on an upper surface and a coupling point on a bottom surface for each part by using a coupling point defined in the part coupled in the part configuration 2.

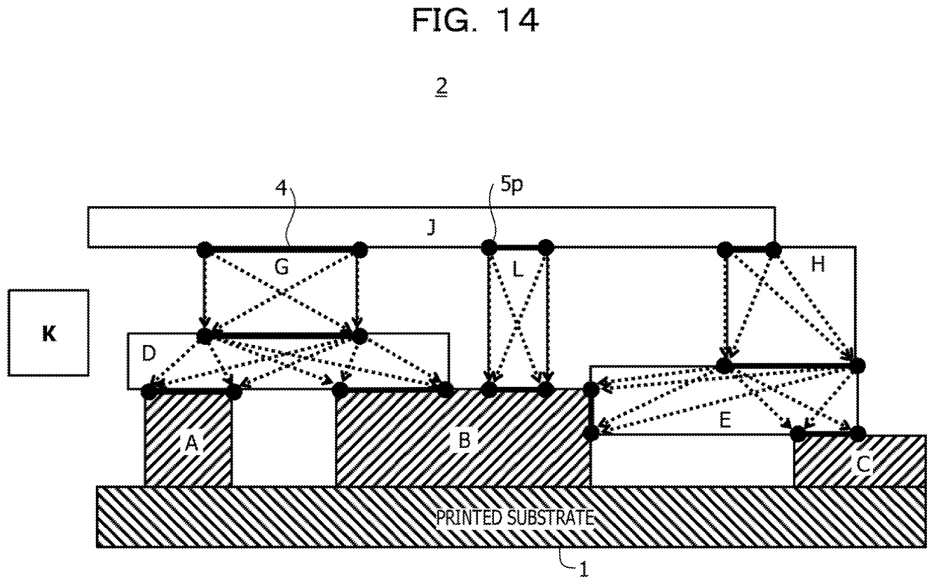

FIG. 14 is a view illustrating a combination of coupling points for calculating a distance. In FIG. 14, in order to simplify the description, the combination of coupling points including a depth direction is omitted. Distances are calculated for the parts G, D, L, H, and E which are disposed in the middle.

In this example, four distances are calculated for the part G, eight distances are calculated for the part D, four distances are calculated for the part L, four distances are calculated for the part H, and eight distances are calculated for the part E.

The shortest route specification unit 44 records the distance in the coupling point distance table 57 every time the distance is calculated. A corresponding relationship between the part configuration 2 and the coupling point distance table 57 will be described.

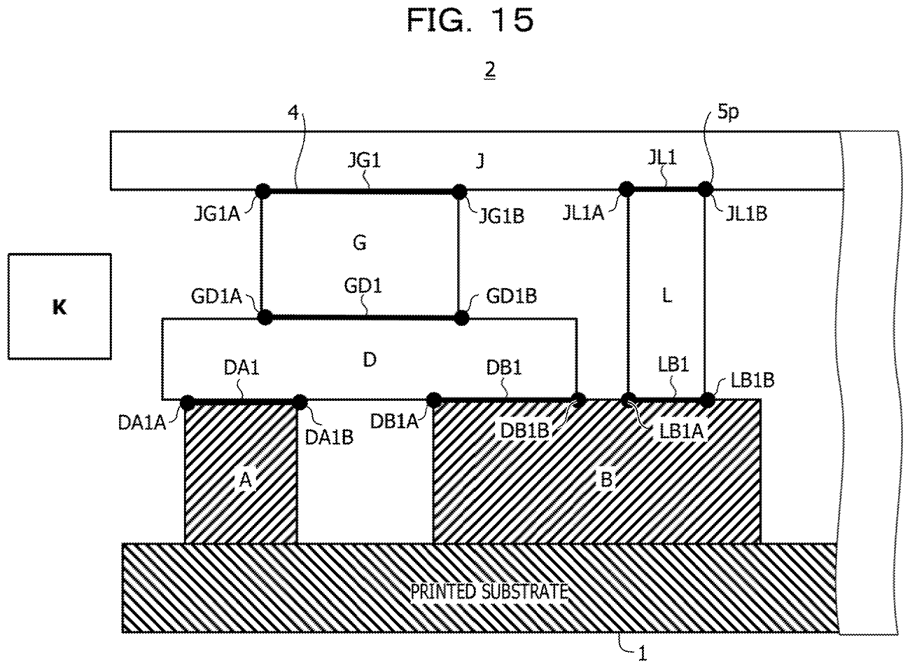

FIG. 15 is a view illustrating an example in which each coupling point is specified in the part configuration. In FIG. 15, in order to simplify the following description, the parts H, D, and C are omitted. The identifiers of the coupling surface and the coupling point are based on the coupling point table 56 in FIG. 13.

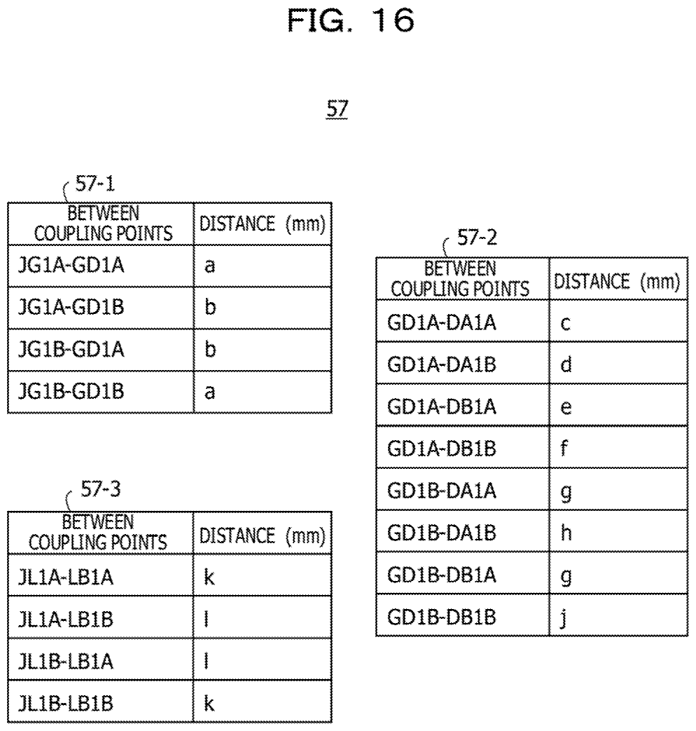

According to the combination of the coupling points illustrated in FIG. 14, the shortest route specification unit 44 calculates a distance, creates a coupling point distance table 57 as illustrated in FIG. 16, and stores the coupling point distance table in the storage unit 130.

FIG. 16 is a table illustrating a data configuration example of a coupling point distance table. Referring to FIG. 16, the coupling point distance table 57 is a table in which a combination of coupling points and a calculated distance are recorded for each part of a distance calculation object. The data configuration example in FIG. 16 includes a part G table 57-1, a part D table 57-2, and a part L table 57-3, for the example of FIG. 15. Although the distance is indicated by a numerical value, it is simply indicated by a lowercase letter of the alphabet.

In the part G table 57-1, distances between the coupling points “JG1A-GD1A” and “JG1B-GD1B” are equal to each other, and are “a” mm, and distances between the coupling points “JG1A-GD1B” and “JG1B-GD1A” are equal to each other, and are “b” mm. In the part L table 57-3, distances between the coupling points “JL1A-LB1A” and “JL1B-LB1B” are equal to each other, and are “k” mm, and distances between the coupling points “JL1A-LB1B” and “JL1B-LB1A” are equal to each other, and are “I” mm.

In the part D table 57-2, a distance between the coupling points GD1A-DA1A is “c” mm, a distance between the coupling points “GD1A-DA1B” is “d” mm, a distance between the coupling points “GD1A-DB1A” is “e” mm, and a distance between the coupling points “GD1A-DB1B” is “f” mm. A distance between the coupling points “GD1B-DA1A” is “g” mm, a distance between the coupling points “GD1B-DA1B” is “h” mm, a distance between the coupling points “GD1B-DB1A” is “i” mm, and a distance between the coupling points “GD1B-DB1B” is “j” mm.

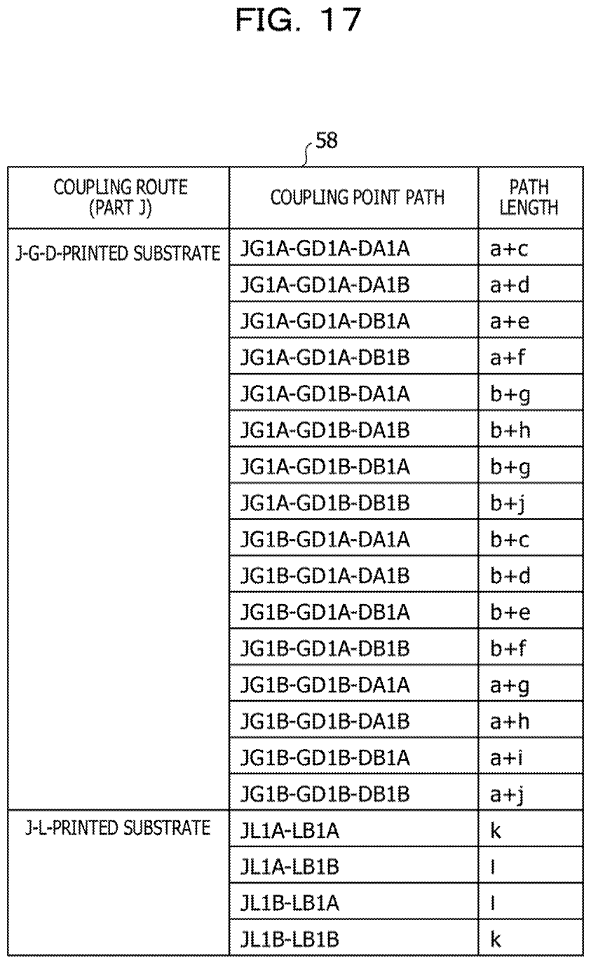

The shortest route specification unit 44 calculates the distance between all routes based on the coupling point distance table 57. FIG. 17 illustrates the route distance table 58 illustrating all routes obtained within a range of the data example illustrated in FIG. 16 and the respective distances when the designer designates the route from the part J.

FIG. 17 is a table illustrating a data configuration example of the route distance table. The route distance table 58 illustrated in FIG. 17 is a table illustrating each route obtained by coupling the parts for each starting part in the all-route table 54 illustrated in FIG. 9 is indicated by a plurality of coupling point paths by coupling between coupling points, and illustrating a path length for each of a plurality of coupling point paths.

In FIG. 17, only a “J-G-D-printed substrate” route and a “J-L-printed substrate” route in FIG. 9 are illustrated for the part J, but path lengths following the coupling point with the same data configuration are indicated for the other routes. The shortest route specification unit 44 acquires the shortest path length for each route based on the coupling between the parts, and specifies the route having the shortest path among the path lengths of all routes.

FIG. 18 is a view for explaining the shortest path. In the part configuration 2, a resistance of a conductor is proportional to the distance, and a noise current flows through a portion with less resistance, but if the distances are equal to each other, the current flows through the surface of the conductive part due to a skin effect.

Taking the route of the part J->the part L->the printed substrate 1 (part B) as an example, as illustrated in FIG. 18, the shortest path length is a distance k of a path from the coupling point “JL1A” to the coupling point “LB1A”, and a path from the coupling point “JL1B” to the coupling point “LB1B”. In this example, since a path of any coupling point is coupled to the same part 8, one of the coupling points may be optionally selected.

In two or more paths in which the route lengths are equal to each other in the same route, as illustrated in FIG. 18, the parts of the coupling destination are not necessarily coincident with each other. In such a case, a priority determination process by the priority determination unit 45 is performed.

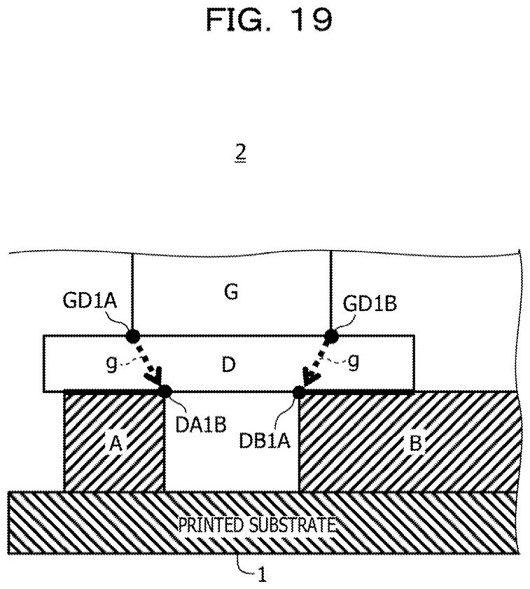

FIG. 19 is a view for explaining an example in which a priority determination is performed by comparing volumes of a plurality of parts in the priority determination process. In FIG. 19, a path from the coupling point “GD1A” to the coupling point “DA1B” Is the same as a path from the coupling point “GD1B” to the coupling point “DB1A”, and is a distance g. The priority determination unit 45 preferentially selects a part of the coupling destination having a large volume.

A: Volume Comparison

Based on coupling from the coupling point “GD1A” to the coupling point “DA1B”, which is the distance g, the priority determination unit 45 refers to the coupling point table in FIG. 13 and the coupling surface table 55 in FIG. 11 to specify the part G and the part A of the coupling partners. Alternatively, if the identifier of the coupling point includes the identifier of the part, two parts of the coupling partners may be specified from the identifier of the coupling point. Similarly, based on coupling from the coupling point “GD1B” to the coupling point “DB1A”, which is the same distance g, the part G and the part B of the coupling partners are specified.

The priority determination unit 45 acquires a volume of each of the part A and the part B to be the coupling destinations of the part D from the part information table 52 illustrated in FIG. 5, compares the obtained two volumes to specify a part having a larger volume. In this example, since the volume of the part B is larger than that of the part A, the path from the coupling point “GD1B” to the coupling point “DB1A” is selected in the route of “G->D->the printed substrate”.

In the part configuration 2 illustrated in FIG. 19, although the part having the largest volume may be preferentially selected among the plurality of parts of the coupling destinations, if the volumes of the plurality of parts are equal to each other, the priority determination is not sufficiently performed only by the volume comparison.

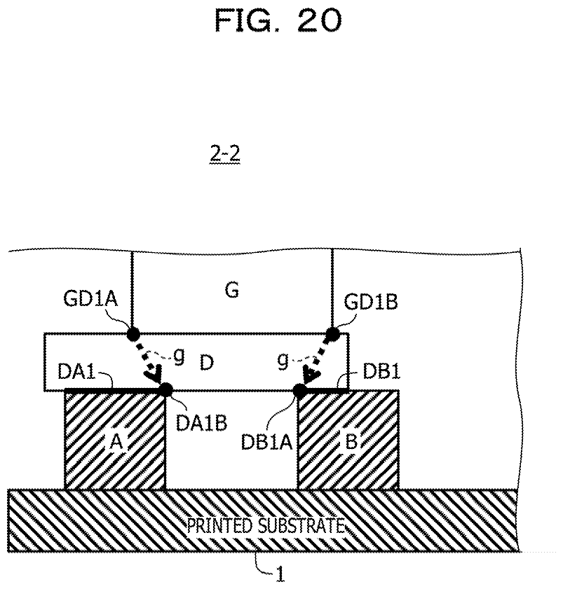

FIG. 20 is a view for explaining an example in which the priority determination is performed by comparing coupling areas of a plurality of parts in the priority determination process. In a part configuration 2-2 of FIG. 20, similar to the part configuration 2 of FIG. 19, a path from the coupling point “GD1A” to the coupling point “DA1B” is the same as a path from the coupling point “GD1B” to the coupling point “DB1A”, and is the distance g, but an example, in which the volumes of the part A and the part B which are the coupling destinations of the part D are equal to each other, is illustrated. If the volumes are equal to each other, the priority determination unit 45 preferentially selects a part having a larger coupling area.

When the priority determination unit 45 performs the volume comparison between the part A and the part B described with reference to FIG. 19 (Step A) to determine that the volumes are equal to each other, step B (coupling area comparison) is performed.

Step B: Coupling Area Comparison

The priority determination unit 45 acquires and compares a coupling area “2.5” cm² of the coupling surface “DA1” between the part D and the part A with a coupling area “1” cm² of the coupling surface “DB1” between the part D and the part B from the coupling surface table 55 illustrated in FIG. 11. The coupling surface “DA1” is larger than the coupling surface “DB1” in coupling area. Therefore, the priority determination unit 45 selects the path to the part A.

In the above description, step B is performed when the priority path may not be selected in step A, but step B may be performed first, and step A may be performed as desirable.

In the present example, one or more mechanical parts of the part configuration 2 may be regarded as a check object. The data configuration example of the shortest route table 59 obtained when the designer selects all of the mechanical parts J, G, D, L, H, E, and K will be described.

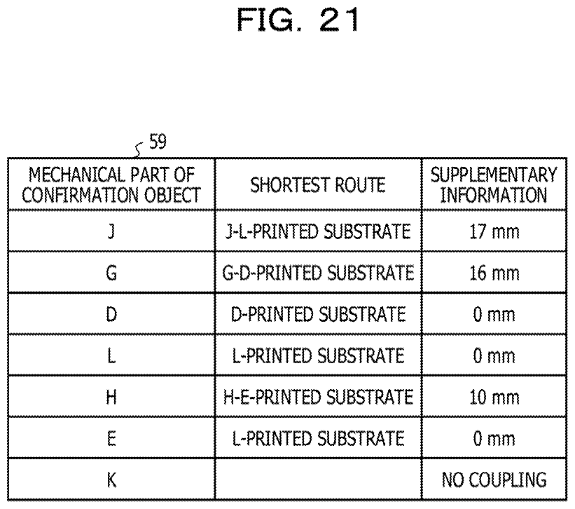

FIG. 21 is a table illustrating the data configuration example of the shortest route table. As illustrated in FIG. 21, the shortest route table 59 includes items such as a mechanical part of the check object, a shortest route, and supplementary information. The display unit 46 displays information on the shortest route on the display device 15 based on the shortest route table 59.

The mechanical part of the check object indicates the identifier of the part selected by the designer from the part configuration 2. The selection of the part is made by displaying the part configuration 2 on the display device 15 according to the operation of the designer, and the shortest route is obtained by using the identifier of the part selected as the starting part of the route. The designer may select one or more starting parts.

The shortest route indicates the shortest route in all routes of the starting part designated by the designer in the all-route table 53. A distance value, exception items, and the like are mainly recorded in the supplementary information. When the part is directly coupled to the printed substrate 1, it is indicated that the distance is “0 mm”. In this example, the parts D, L, and E are applied.

When there is a part which is not coupled to any part, a message for making the designer know the fact is indicated. In this example, “no coupling” is indicated with respect to the part K. Information such as a distance “0 mm” and “no coupling” is information obtained from the part coupling table 53 (FIG. 8).

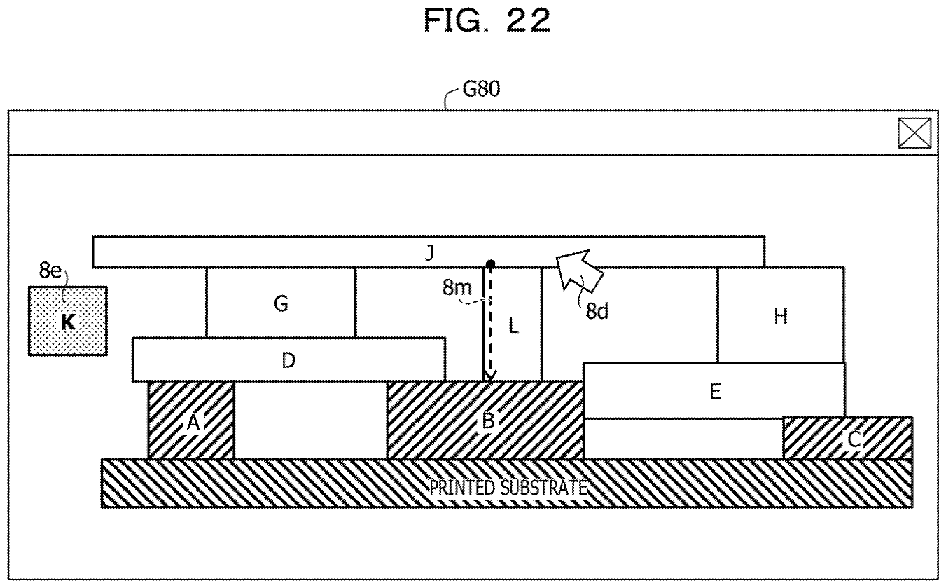

FIG. 22 is a view illustrating a display example of the shortest route over the part configuration. On a screen G80 illustrated in FIG. 22, the part configuration 2 is displayed by the display unit 46 based on the CAD design information 51. A shortest route 8m is indicated in accordance with a designation 8d of the part L by the designer. The part K having no coupling detected by the route search unit 42 is displayed in a specific color 8e indicating an error.

By confirming the screen G80, the designer may visually check the shortest route 8m over the part configuration 2, so that it is possible to easily determine suitability of the design. Since the presence or absence of the no-coupling part K or the like may be checked, the check operation of the designer may be reduced, and the design review may be efficiently performed. Although FIG. 22 illustrates a display example in which only the shortest route 8m is displayed over the part configuration 2, all routes may be displayed, and the shortest route 8m may be displayed by highlighting different from the other routes.

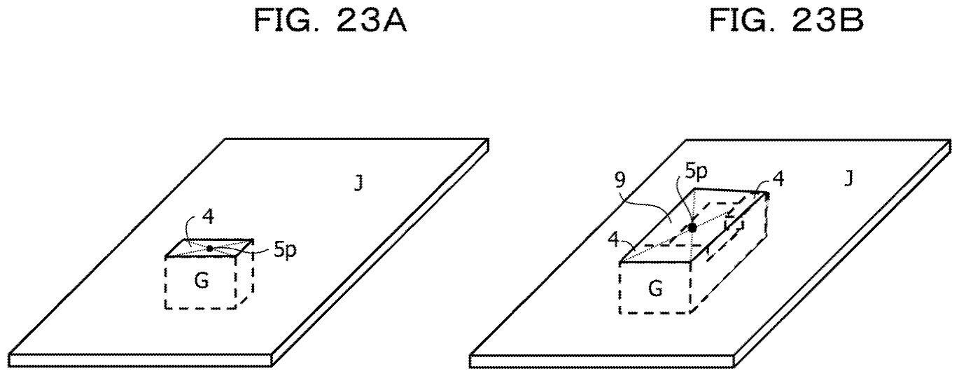

FIG. 23 (i.e., FIGS. 23A and 23B) is a view for explaining a second example of the coupling point disposition method. In FIG. 23, a method of disposing the number of coupling points 5p at a minimum will be described. Similar to FIG. 12A, FIG. 23A illustrates a case where there is one coupling surfaces in the coupling between the part G and the part J.

In FIG. 23A, the correspondence table creation unit 43 disposes the coupling point 5p at a center of the coupling surface 4. In order to dispose one coupling point 5p on the coupling surface 4 between the part G and the part J, it is possible to reduce the disposition to ¼ with respect to the disposition of four coupling points 5p in FIG. 12A. Since it is only desirable to calculate the distance for all routes illustrated in FIG. 9 by the number of routes, it is possible to greatly reduce a load of the distance calculation by the shortest route specification unit 44 less than that in the case illustrated in FIG. 12A.

Similar to FIG. 128, FIG. 23B illustrates a case where two coupling surfaces 4 exist in the coupling between the part G and the part J. In FIG. 23(B), the correspondence table creation unit 43 creates a minimum inclusion rectangle 9 including two coupling surfaces 4, and forms a coupling surface between the part G and the part J. The correspondence table creation unit 43 disposes the coupling point 5p at a center of the inclusion rectangle 9. If the part G is a circle or an ellipse, only the center point 5c illustrated in FIG. 12C may be disposed as the coupling point 5p.

In FIG. 23B, since one coupling point 5p is disposed with respect to the inclusion rectangle 9 including two coupling surfaces 4, the correspondence table creation unit 43 may reduce the disposition to ⅛ with respect to the disposition of eight coupling points 5p in FIG. 12B. Similar to FIG. 23A, since it is only desirable to calculate the distance for all routes illustrated in FIG. 9 by the number of routes, it is possible to greatly reduce the load of the distance calculation by the shortest route specification unit 44 less than that in the case illustrated in FIG. 12B.

As described above, in the second example of the coupling point disposition method, since the number of coupling points 5p is reduced, the calculation of the distance between the coupling points 5p is reduced, and the number of records in the coupling point distance table 57 (FIG. 16) may also be reduced. As a result, in the route distance table 58 (FIG. 17), one distance is illustrated for each coupling route, so that a size of the table may be greatly reduced.

On the other hand, since the EMC noise tends to propagate through the surface of the part, if priority is given to distance accuracy, it is desirable to apply the first example of the coupling point disposition method illustrated in FIG. 12. However, if it is desired to check the shortest route and the distance thereof by calculation, it is effective to use the second example of the coupling point disposition method as described with reference to FIG. 23.

Next, as a method of improving the accuracy by the second example of the coupling point disposition method illustrated in FIG. 23, it may be considered to dispose the coupling point 5p at a center of an outer periphery of the coupling surface 4 by focusing on the tendency of the EMC noise propagating through the surface of the part.

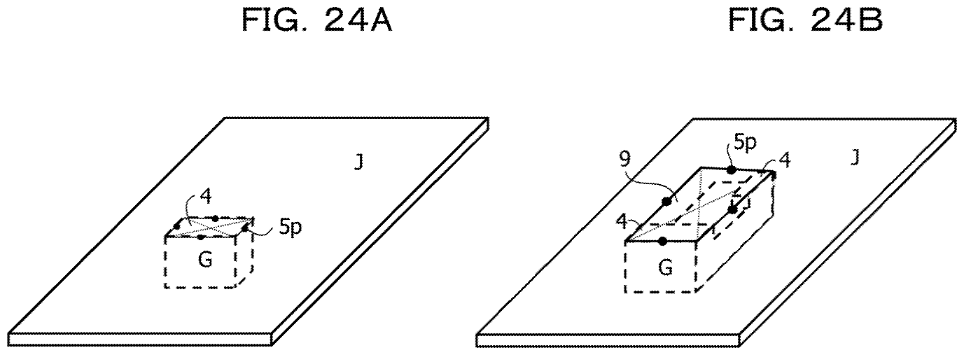

FIG. 24 (i.e., FIGS. 24A and 24B) is a view for explaining a third example of the coupling point disposition method. In FIG. 24, a method of disposing a coupling point 5p at a center of an outer periphery of a coupling surface 4 will be described. Similar to FIG. 12A, FIG. 24A illustrates a case where there is one coupling surface in the coupling between the part G and the part J.

In FIG. 24A, a correspondence table creation unit 43 disposes the coupling point 5p at the center of the outer periphery of the coupling surface 4. Since four coupling points 5p are disposed on the coupling surface 4 between the part G and the part J, the number of coupling points 5p is the same as that in FIG. 12A.

On the other hand, similar to FIG. 12B, FIG. 24B illustrates a case where two coupling surfaces 4 exist in the coupling between the part G and the part J. Similar to FIG. 23B, in FIG. 24B, the correspondence table creation unit 43 creates a minimum inclusion rectangle 9 including two coupling surfaces 4, and forms a coupling surface between the part G and the part J. The correspondence table creation unit 43 disposes a coupling point 5p at a center of an outer periphery of the inclusion rectangle 9.

In FIG. 12B, whereas eight coupling points 5p are provided, in FIG. 24A, only four coupling points 5p are provided, so that the number of coupling points 5p may be reduced to ½. A load of the distance calculation by the shortest route specification unit 44 may be reduced as compared with the case illustrated in FIG. 12B. In a case where the part G is a circle or an ellipse, since the description thereof is similar to that of FIG. 12C, description thereof will be omitted.

As described above, in the third example of the coupling point disposition method, when two parts are coupled by two or more coupling surfaces 4, the calculation amount may be reduced from the first example of the coupling point disposition method. On the other hand, in FIG. 24A, although a calculation amount is substantially equal to that in FIG. 12A, since the accuracy of the distance calculation is good in the first example of the coupling point disposition method, the fourth example in which FIG. 12A, FIG. 12C, and FIG. 24B are applied may also be provided.

As described above, since the coupling route calculation apparatus 100 according to the present example specifies and displays the shortest route for each mechanical part of the check object designated by the designer, the designer may easily check the route through which the EMC noise may propagate without depending on skill.

For example, the embodiments not limited to the examples disclosed and various modifications and various changes may be made without departing from the scope of the claims.

In the present examples, a part of the collection unit 41 and the route search unit 42 is an example of a route extraction unit, and the correspondence table creation unit 43 is an example of a coupling information extraction unit. A part of the shortest route specification unit 44 is an example of a distance calculation unit, a part of the shortest route specification unit 44 and the priority determination unit 45 are an example of a route selection unit, and the display unit 46 is an example of an output unit.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a illustrating of the superiority and inferiority of the invention. Although one or more embodiments of the present invention have been described in detail, it should be understood that the various changes, substitutions, and alterations could be made hereto without departing from the spirit and scope of the invention.

What is claimed is:

1. A non-transitory computer-readable storage medium for storing a program which causes a processor to perform processing for calculating a coupling route of mechanical parts, the processing comprising:
extracting, from CAD data, information on each of a plurality of routes through which electricity is capable of flowing from a plurality of the mechanical parts constituting a conductive structure excluding an electronic part mounted over a substrate, to the substrate;
extracting each of a coupling surface and a coupling point between the mechanical parts or between the mechanical part and the electronic part;
calculating each of distances between the extracted coupling points;
selecting a route having a shortest distance among the plurality of routes from a specific mechanical part in the plurality of mechanical parts to the substrate; and
outputting the selected shortest route.

2. The non-transitory computer-readable storage medium according to claim 1, wherein the program causes a computer to further execute:
selecting a route to a part having a largest volume among two or more parts out of the electronic part and the mechanical parts other than a certain mechanical part, when the two or more parts are coupling destinations of the certain mechanical part, and distances between a coupling point of a coupling source in the certain mechanical part and respective coupling points of the two or more parts as the coupling destinations are equal to each other.

3. The non-transitory computer-readable storage medium according to claim 1, wherein the program causes a computer to further execute:
selecting a route to a part having a largest area of a coupling surface coupling to a certain mechanical part among two or more parts out of the electronic part and the mechanical parts other than a certain mechanical part, when the two or more parts are coupling destinations of the certain mechanical part, and distances between a coupling point of a coupling source in the certain mechanical part and respective coupling points of the two or more parts as the coupling destinations are equal to each other.

4. A method for calculating a coupling route of mechanical parts which is executed by a computer, the method comprising:
extracting, from CAD data, information on each of a plurality of routes through which electricity is capable of flowing from a plurality of the mechanical parts constituting a conductive structure excluding an electronic part mounted over a substrate, to the substrate;
extracting each of a coupling surface and a coupling point between the mechanical parts or between the mechanical part and the electronic part;
calculating each of distances between the extracted coupling points;
selecting a route having a shortest distance among the plurality of routes from a specific mechanical part in the plurality of mechanical parts to the substrate; and
outputting the selected shortest route.

5. An apparatus for calculating a coupling route of mechanical parts, the apparatus comprising:
a memory; and
a processor coupled to the memory, the processor being configured to
execute a route extraction process that includes extracting, from CAD data, information on each of a plurality of routes through which electricity is capable of flowing from a plurality of the mechanical parts constituting a conductive structure excluding an electronic part mounted over a substrate, to the substrate,
execute a coupling information extraction processing that includes extracting each of a coupling surface and a coupling point between the mechanical parts or between the mechanical part and the electronic part,
execute a distance calculation processing that includes calculating each of distances between the extracted coupling points,
execute a route selection processing that includes selecting a route having a shortest distance among the plurality of routes from a specific mechanical part in the plurality of mechanical parts to the substrate, and
execute an output processing that includes outputting the selected shortest route.
